(19) United States
(12) Patent Application Publication
(10) Pub. No.: US 2021/0364997 A1
(43) Pub. Date: Nov. 25, 2021

(54) Machine Tool and Method for Preparing a Machining of a Material-removing Rotary Tool

(71) Applicant: Walter Maschinenbau GmbH, Tübingen (DE)

(72) Inventor: Siegfried Hegele, Dusslingen (DE)

(21) Appl. No.: 16/963,404

(22) PCT Filed: Jan. 9, 2019
(86) PCT No.: PCT/EP2019/050444

§ 371 Date: Jul. 20, 2020

(30) Foreign Application Priority Data
Jan. 23, 2018 (DE) 10 2018 101 407.4

(51) Int. Cl. G05B 19/401; B23B 51/00

(52) U.S. Cl. CPC G05B 19/401; B23B 51/00; G05B 2219/37558; G05B 2219/37559; G05B 2219/50311; G05B 2219/45159; G05B 2219/45161; G05B 2219/50214; G05B 2219/50309; G05B 2219/37575

(57) ABSTRACT

At least one coordinate value (z1, z2, α1, α2) of a cutting body (35) can be acquired by means of an acquisition device (27) and transferred to the control device (25). This at least one coordinate value (z1, z2, α1, α2) of each cutting body (35) can be used for the rest of the method in the control device (25). This at least one coordinate value (z1, z2, α1, α2) which is determined on the basis of the at least one image (B) can be directly taken into account during the processing of the rotational tool (13). Alternatively or additionally, this at least one coordinate value (z1, z2, α1, α2) which is determined on the basis of the at least one image (B) can be used to determine at least one further coordinate value, in particular using a sensing device (29).

The invention relates to a machine tool for machining—producing or reworking—a material-removing rotary tool, and a method usable for this purpose.

Rotary tools can comprise a tool body on which there are arranged a plurality of cutting bodies. In the case of a first tool type the cutting bodies can be formed as inserts in or on the tool body, such that their edges transition substantially continuously into the tool body. Such inserts can be provided on the end face and/or along the shaft of the tool body. The cutting bodies can be arranged in the case of a second tool type on carrier faces in particular in the region of the outer circumference and can form cutting plates.

The tool body consists of a different material as compared to the at least one cutting body. The material of the at least one cutting body in particular is harder than the material of the tool body. For example, the tool body can be made substantially of a metal or a metal alloy. The cutting body can be made for example of PCD (polycrystalline diamond).

The rotary tool to be machined can be a blank, wherein the cutting edges are to be exposed on the cutting body or are to be produced in accordance with a target geometry. In particular in the case of rotary tools of the first tool type, the blanks are blanks that are to be finished. In the case of rotary tools of the second tool type the blanks can be in particular blanks that are to be finished or used rotary tools that are to be reworked. When producing the rotary tool the cutting bodies are fastened to the tool body by sintering or soldering or adhesive bonding, or are integrally bonded thereto in some other way. Due to the tolerances when arranging the cutting bodies on carrier surfaces of the tool body, in particular in the case of the second tool type, the subsequent machining is hindered. The exact position or orientation of the cutting bodies relative to a machine coordinate system must first be determined. In the case of rotary tool blanks of the first tool type the cutting bodies transition into the tool body. For the subsequent machining it is necessary to know the course of the edge of the cutting bodies so as to be able to machine the tool body and the cutting bodies using different machine tools and/or using different material-removal processes.

Proceeding from this basis, the object of the present invention can be considered that of achieving a simple determination of the position of the cutting bodies.

This object is achieved by a machine tool having the features of claim 1 and a method having the features of claim 13.

The machine tool can be embodied as a laser processing machine, as a grinding machine, as an eroding machine, or as a combination of a plurality of these machine types, and in a preferred exemplary embodiment is embodied as a combined grinding and eroding machine. The machine tool is configured to machine a material-removing rotary tool, for example within the scope of production of the rotary tool or reworking thereof. The rotary tool to be machined by means of a tool of the machine tool has a tool body extending along a tool longitudinal axis, with a cutting body, and preferably a plurality of cutting bodies, arranged on and/or in said tool body. The at least one cutting body for example can be fastened to the tool body by sintering. In other exemplary embodiments the at least one cutting body can be fastened to the tool body by soldering.

The machine tool has a control device and a detection device, in particular an optical detection device, such as a scanner and/or a camera, operating contactlessly and connected to the control device for communication therewith. The detection is used to capture detection data, for example at least one image, which data characterises the rotary tool and makes it possible to distinguish the at least one cutting body from the tool body, such that it is possible to identify or determine one or more transition points between the tool body and at least one cutting body in the control device. This distinguishability can be possible for example on the basis of a contrast in an image or different absorption and/or reflection properties of the at least one cutting body as compared to the tool body. The main axis or optical axis of the detection device or the camera can be oriented substantially parallel or at right angles to the tool longitudinal axis depending on the arrangement of the at least one cutting body on the tool body.

The machine tool additionally has an axis arrangement. By controlling the axis arrangement by means of the control device, the tool of the machine tool and the rotary tool can be moved or positioned relative to one another, in particular during the machining of the rotary tool.

The control device is configured to determine at least one coordinate value of each cutting body attached to the tool body, on the basis of the detection data or the at least one image. The at least one coordinate value describes an edge position of an edge of the at least one cutting body in relation to a reference coordinate system. The reference coordinate system is defined by the detection device and can be a machine coordinate system of the machine tool. This is dependent on whether the detection device is arranged in a stationary manner relative to the machine coordinate system and positions in the detection data or in the image can thus be associated directly with the machine coordinate system.

On the basis of this at least one coordinate value, the position of one or more cutting bodies in relation to the reference coordinate system can be determined in the control device, optionally with use of further data, for example construction data of the rotary tool to be machined.

In the case of a rotary tool of the first tool type, at least one cutting body is arranged on the end face of the tool body. Detection data—for example at least one image or precisely one image—is captured from the end face of the tool body and determines at least one angle coordinate value of at least one edge of the at least one cutting body in relation to the reference coordinate system. The rotary tool is positioned in a clamping device of the machine tool in such a way that the relative orientation of the rotary tool in relation to the reference coordinate system is known, such that the position of the at least one edge of the at least one cutting body in the machine coordinate system of the machine tool is thus given.

It is sufficient to know the position of a single edge or some of the edges of the at least one cutting body in relation to the machine coordinate system of the machine tool if the relative position and/or dimensioning of the provided cutting bodies are/is stored or known in the control device of the machine tool.

The subsequent machining can selectively machine the tool body and the at least one cutting body separately or individually, for example using different tools and/or different machining processes. In one exemplary embodiment the tool body can firstly be machined by grinding using a grinding tool so as to achieve a large volume of removed material per unit of time. The tool body and/or the at least one cutting body can then be machined by erosion using an eroding tool so as to achieve the target geometry. The control device can be configured to carry out this process sequence.

In the case of the rotary tool of the second tool type at least the approximate position of each cutting body is determined by means of the detection data or the at least one image, since this position may deviate from the target position depending on the method by which the at least one cutting body is attached to the tool body. The actual current position of the at least one cutting body can be easily and quickly detected by evaluation of the detection data and by the determination of at least one coordinate value in relation to the reference coordinate system. In particular, a longitudinal coordinate value parallel to the tool longitudinal axis and/or a radial coordinate value at right angles to the tool longitudinal axis can be determined. The position determined in this way can be used in the control device for machining the at least one cutting body. Alternatively or additionally, the determined (approximate) position of each provided cutting body can be used to determine at least one further coordinate value and/or at least one more precise coordinate value of each cutting body by means of a probe device operating in a contact-based manner or contactlessly. For example, this further coordinate value can be an angle coordinate value relative to the longitudinal axis of the tool. Alternatively or additionally, the at least one coordinate value already determined at least approximately by evaluation of the detection data (at least one camera image) can be determined more precisely by the probing. Following this determination of the at least one further coordinate value, the at least one cutting body can be machined by means of the tool of the machine tool.

By means of the invention it is possible to quickly determine the position of each provided cutting body. The invention can thus be used for the production of new rotary tools, wherein the at least one cutting body and/or the tool body is provided for the first time with its target geometry by erosion or grinding. The method is also suitable for used tools which have experienced a certain level of wear, so as to rework the cutting body or cutting bodies and return it/them to the desired form as far as possible. At least an approximate position of each cutting body can be determined on the basis of the detection data by means of the detection device. This knowledge can then be used directly for the machining and/or determination of further or more precise coordinate values.

Whilst the detection data is being captured, the rotary tool is positioned in a detection region of the detection device. In one exemplary embodiment a gripping device, such as a robot arm or another transfer device, can be used for this purpose. The gripping device can additionally be configured to arrange the rotary tool in the clamping device of the machine tool. The rotary tool is held in the clamping device in a clamped manner during the machining.

In a preferred embodiment the detection region is located outside the working region of the machine tool. The gripping device can be designed in this embodiment to position the rotary tool firstly in the detection region and to arrange it in the clamping device once the detection data has been captured.

In a further embodiment the gripping device can be configured to move and to position the detection device. In this embodiment it is possible to arrange the rotary tool for example in the clamping device and to position the detection device in such a way that the detection data of the clamped rotary tool is captured. Once the detection data—for example at least one image—has been captured, the detection device can be moved out again of the working region by means of the gripping device.

It is also possible to provide a gripping device for moving and positioning the rotary tool and a separate transfer device for moving the detection device.

It is preferred if the control device is configured to determine a first coordinate value and a second coordinate value for each provided cutting body on the basis of the detection data, in particular at least one image. The first coordinate value describes an edge position of a first edge of a cutting body and the second coordinate value describes an edge position of a second edge of the same cutting body. A region is thus defined between the first coordinate value and the second coordinate value, within which region the cutting body in question is located.

The detection data can additionally be used to determine the number of provided cutting bodies and/or the number of provided separations and/or the approximate relative position of the cutting bodies. This data can be used for the rest of the process for machining the rotary tool and/or can be used to determine further coordinate values.

In one exemplary embodiment the machine tool can comprise a probe device movable relative to the rotary tool. The probe device is in particular configured to probe an edge and/or a surface of a cutting body or each cutting body at least at one probe point. The probing can be performed in a contact-based manner with a mechanical probe, or contactlessly, for example with an optically operating probe device. The position of the probe point at the particular cutting body can be determined on the basis of the probe signal of the probe device. This probing is used in particular in the case of rotary tools of the second tool type.

For example, the control device can be configured to use the at least one coordinate value determined on the basis of the evaluation of the detection data to determine a plurality of probe points on each provided cutting body. The probe points are located preferably between the first coordinate value and the second coordinate value. If merely a single coordinate value is known, the known approximate size of the at least one cutting body can be taken into consideration so as to define, in combination with the one coordinate value, probe points that are located at or on the cutting body. The at least approximate size of the at least one cutting body can be either input by an operator or determined by valuation of the detection data.

In a preferred exemplary embodiment the control device is configured to control the axis arrangement in such a way that the probe device probes each provided cutting body in succession at the determined probe points. The control device is in particular also configured to determine, for each probe point, one or more probe measurement values describing the position of the probe point in the reference coordinate system. On the basis of these probe measured values, the control device is able to precisely determine the position and orientation of each cutting body, in such a way that precise machining of the cutting bodies by means of the tool of the machine tool is possible. Thus, each cutting body can obtain a geometry corresponding to a target geometry predefined in the control device.

In one exemplary embodiment the control device is configured to determine, for each cutting body, at least one angle coordinate value and/or at least one radial coordinate value in relation to the reference coordinate system on the basis of the probe measured values.

It is preferred if a plurality of probe points or all probe points at which each cutting body is probed lie on a common flat surface of the cutting body in question. By probing three or more probe points on a common flat surface, the orientation or position of the cutting body in space in relation to the reference coordinate system can be determined.

One or more probe points can also be selected at the first edge and/or the second edge. In this way, as a result of the probing, a more precise determination of the position of the first edge and/or the second edge can be achieved. A more precise first coordinate value and/or a more precise second coordinate value so to speak can be determined. This determination is advantageous if the determination of the first coordinate value and/or the second coordinate value on the basis of the detection data does not provide sufficient accuracy for the machining of the at least one cutting body.

A method according to the invention comprises the following steps:

The rotary tool is firstly positioned in the detection region of a detection device. Detection data, at least one image, is then captured from the rotary tool. At least one coordinate value of the at least one cutting body arranged on the tool body of the rotary tool is determined on the basis of the detection data. The at least one coordinate value describes an edge position of an edge of the particular cutting body in relation to a reference coordinate system, which for example can be arranged in a fixed position relative to a machine coordinate system of the machine tool.

On the basis of this at least one coordinate value, the at least one cutting body can then be machined. Additionally or alternatively, at least one further coordinate value can be determined for each cutting body, for example an angle coordinate value or a radial coordinate value of a surface and/or an edge of the particular cutting body in relation to a reference coordinate system, on the basis of the at least one coordinate value determined in the manner described above.

The detection data is captured in the case of rotary tools of the first tool type preferably in such a way that the main axis or optical axis of the detection device is oriented substantially parallel to the tool longitudinal axis of the rotary tool, so as to capture the end face of the rotary tool. A substantially parallel orientation is understood to mean that the angle between the main axis or optical axis of the detection device and the longitudinal axis of the rotary tool preferably deviates via most 15 degrees or at most 10 degrees or at most 5 degrees from the parallel orientation.

The detection data is captured in the case of rotary tools of the second tool type preferably in such a way that the main axis or optical axis of the detection device is oriented substantially at right angles to the tool longitudinal axis of the rotary tool. A substantially right-angled orientation is to be understood to mean that the angle between the main axis or optical axis of the detection device and the longitudinal axis of the rotary tool preferably deviates by most 15 degrees or at most 10 degrees or at most 5 degrees from a right angle.

Advantageous embodiments of the invention will become clear from the dependent claims, the description, and the drawings. Exemplary embodiments of the invention will be explained in detail hereinafter with reference to the accompanying drawings, in which:

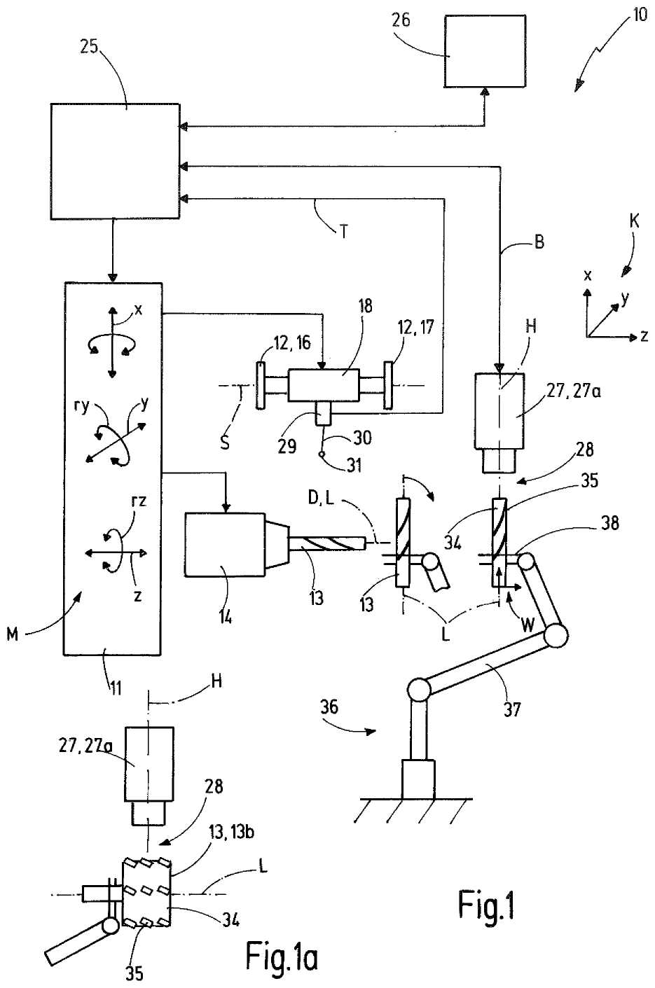

FIG. 1 shows a schematic, block diagram-like illustration of a machine tool according to the invention and a rotary tool of a first tool type,

FIG. 1a shows a schematic illustration of a rotary tool of a second tool type and positioning thereof when detection data is captured,

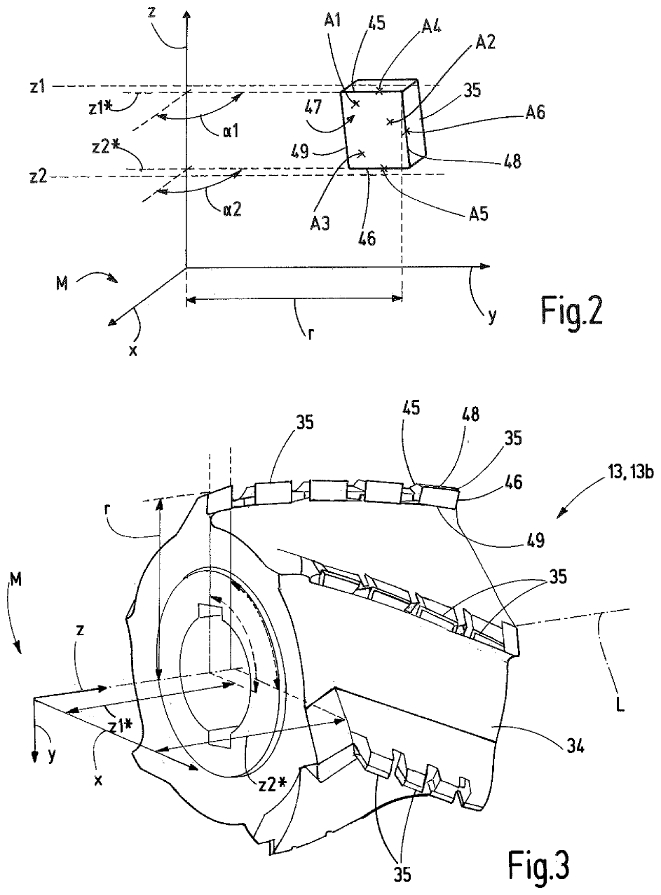

FIG. 2 shows a schematic illustration of a cutting body and position thereof with orientation relative to a reference coordinate system, and

FIG. 3 shows an exemplary embodiment of a rotary tool to be machined in a perspective illustration,

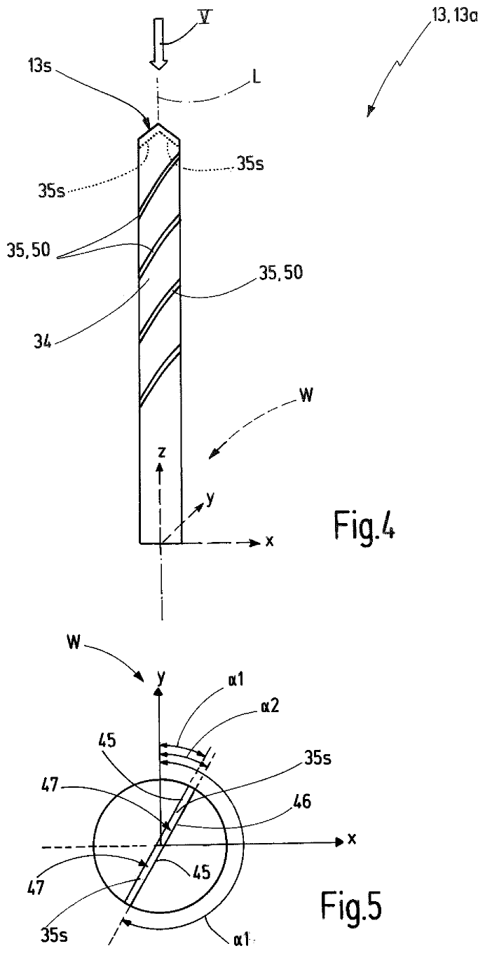

FIG. 4 shows a schematic illustration of an exemplary embodiment of a rotary tool of a first tool type in a side view, and

FIG. 5 shows a plan view of an end face of the rotary tool from FIG. 4.

FIG. 1 shows schematically a machine tool 10 in a heavily simplified manner in the form of a block diagram, wherein the machine tool according to the example is a combined grinding and eroding machine. The machine tool 10 comprises an axis arrangement 11 comprising at least one and preferably more translatory and/or rotary machine axes. A tool 12 of the machine-tool and a rotary tool 13 to be machined can be moved and/or positioned relative to one another by means of the axis arrangement 11, so as to machine the rotary tool 13 by means of the tool 12 of the machine tool. The machine tool 10 comprises a clamping device 14 in order to clamp the rotary tool. During the machining, the rotary tool 13 remains clamped in the clamping device 14.

The tool 12 of the machine tool in the exemplary embodiment comprises a grinding tool 16 or an eroding tool 17. The type of tool is dependent on whether the machine is a grinding machine, an eroding machine, or a combined grinding and eroding machine. The tool 12 of the machine tool, and in accordance with the example the grinding tool 16 or the eroding tool 17, can be driveable by a machine spindle 18 about a spindle axis S. An eroding tool 17 can be driven in rotation about the spindle axis S during the machining of the rotary tool 13, or alternatively can remain still.

The axis arrangement 11 according to the example comprises a plurality of translatory and rotary axes, such that a relative movement between the clamping device 14 or a rotary tool 13 clamped therein and the tool 12 of the machine tool is possible in up to three linear degrees of freedom x, y, z and up to three rotary degrees of freedom rx, ry, rz. Which of the machine axes or the translatory or rotary degrees of freedom is designed here for the movement of the clamping device 14 or of the tool 12 of the machine tool is dependent on the specific design of the machine tool 10 and can vary.

In order to control the axis arrangement 11, the machine tool 10 comprises a control device 25. The control device 25 is connected to the axis arrangement 11 and a control interface 26 for communication therewith. The control interface 26 is configured to transmit inputs made by an operator to the control device 25 and to display information regarding the status of the machine tool 10 to the operator. For example, such information can concern current settings, the current operating state of the machine, the course of a machine programme, any errors, etc.

The machine tool 10 additionally comprises a detection device 27 operating contactlessly and formed in accordance with the example by camera 27a. Alternatively or additionally, the detection device 27 can also comprise a scanner or another detection unit operating contactlessly.

The detection device 27, and according to the example the camera 27a, can be configured to capture detection data, according to the example at least one image B of the rotary tool 13 arranged in a detection region 28 of the detection device 27 or the camera 27a and to transmit said data to the control device 25. The control device 25 is configured to control the camera 27a to capture at least one image B and to evaluate the image data of a received image B. To this end, the control device 25 performs corresponding image evaluation processes, for example in order to identify edges or surfaces of the rotary tool 13 and the recorded image B. The captured rotary tool 13 is displayed in the image in relation to a reference coordinate system K defined by the camera 27a.

The camera 27a is preferably arranged outside the working region of the machine tool 10. In the exemplary embodiment shown here the camera 27a is arranged in a fixed manner, for example externally on a cladding or a machine frame of the machine tool 10 or on a frame of a robot or a transfer device. The camera 27a can also be arranged movably or immovably at other positions outside the working region.

The machine tool 10 may optionally additionally comprise a probe device 29. The probe device 29 is configured to probe the rotary tool 13 at one or more probe points in a contact-based manner or contactlessly, so as to determine the exact position of the probe point relative to a machine coordinate system M of the machine tool (FIGS. 2 and 3). The probe device 29 may be advantageous when machining rotary tools of a certain tool type and might not be required for other tool types of rotary tool.

In the exemplary embodiment of the probe device 29 described here, a probe element 30, for example a probe stylus, is provided, with a probe body 31 arranged at the free end thereof. The probe body 31 for example may be formed by a probe ball. If the probe body 31 comes into contact with an object, for example the rotary tool 13, this contact is detected by the probe device 29 and a corresponding probe signal T, indicating the contact, is transmitted to the control device 25. To this end, the probe device 29 is connected to the control device 25 for communication therewith.

Alternatively to the presented probe device 29, a probe device operating contactlessly can also be used. The probe device 29 for example can operate optically and can detect objects in a detection region of the probe device, so as to determine the position thereof. A further possibility lies in the probe device 29 detecting the approach towards an object, without actually contacting said object, and determining the position of the object in this way.

As shown schematically in FIG. 1, the probe device 29 in the exemplary embodiment is located on the machine spindle 18 and can be moved and positioned relative to the clamping device 14 jointly with the machine spindle 18 and the tool 12 of the machine tool via a machine axis of the axis arrangement 11. Alternatively to this embodiment, it is also possible to arrange the probe device 29 in a stationary manner relative to a machine frame or a machine bed and to move the clamping device 14 relative to the probe device 29 for the probing of the rotary tool 13.

The rotary tool 13 has a tool body 34 which extends along a tool longitudinal axis L. The tool longitudinal axis L forms the axis of rotation of the rotary tool 13 when this is driven in rotation in order to machine a workpiece. One cutting body or, as in the shown exemplary embodiments, a plurality of cutting bodies 35 is/are arranged on or integrated in the tool body 34. Cutting edges are provided on the cutting bodies 35 or cutting bodies are to be exposed or machined.

FIGS. 4 and 5 show a rotary tool 13 of a first tool type 13a. In the case of this first tool type 13a the at least one cutting body 35 is integrated as an insert 50 into the tool body 34 in such a way that the edges of the at least one cutting body 35 do not form an edge that can be probed by contact by means of the probe device 29 if the rotary tool 13 is still an unmachined blank and has not yet been finished. FIGS. 4 and 5 show the blank (rotary tool 13 of the first tool type 13a), wherein the cutting edges have to be exposed by means of the machine tool 10 or have to be machined in accordance with the desired target geometry.

The blank of the rotary tool 13 of the first tool type 13a comprises at least one cutting body, and according to the example two cutting bodies 35, on the end face 13a, which form end-face cutting bodies 35s so to speak. In the case of the blank, which has not yet been machined to a finished state, these end-face cutting bodies 35s are integrated in the tool body 34 in such a way that they cannot be probed by means of the probe device 29 operating in a contact-based manner.

In a further exemplary embodiment of a rotary tool 13 of a second tool type 13b (FIGS. 1a and 3), the cutting bodies 35 are formed as cutting plates and are fastened externally to the tool body 34 at appropriate carrier surfaces, for example by way of an integrally bonded connection, in particular a soldered connection. The positioning of the cutting bodies 35 on the tool body 34 can therefore be subject to a relatively large tolerance, such that the actual positions and orientations of the cutting bodies 35 do not coincide exactly with target positions and target orientations. This tolerance hinders the machining of the cutting bodies 35 by the tool 12 of the machine-tool in order to produce a predefined target geometry at the cutting body 35. The target geometry to be produced is stored in the control device 25 or a memory connected thereto.

The machine tool 10 additionally comprises a gripping device 36. The gripping device 36 is configured to move and/or to position the rotary tool 13. The gripping device 36 can be embodied in many different ways. In the exemplary embodiment shown schematically in FIG. 1, the gripping device 36 has a gripping arm 37 with one or more joints and/or rotary axes. The gripping arm 37 is fastened at one end, for example to the machine frame or to the substrate on which the machine tool 10 is installed, or to a base or a pedestal of the gripping device 26. The opposite free end of the gripping arm 37 comprises a gripper 38, by means of which the gripping device 26 can grip, pick up and move an object. According to the example the gripper 38 can be configured to grip the tool body 34 in order to move and position the rotary tool 13.

According to example the gripping device 36 is configured to position the rotary tool 13 in the detection region 28 of the detection device 27 or the camera 27a such that the main axis of the detection device 27 or the optical axis H of the camera 27a is oriented substantially parallel or at right angles to the tool longitudinal axis L of the rotary tool 13. The angle between the optical axis H of the camera 27a and the tool longitudinal axis L can deviate up to 15 degrees or up to 10 degrees or up to 5 degrees from the parallel or right-angled orientation. It should be noted here that the optical axis H and the longitudinal axis L do not have to be congruent or do not have to intercept one another, but can also be arranged offset relative to one another. The offset should be kept as small as possible.

In the case of the rotary tool 13 of the first tool type 13a, which comprises at least one cutting body 35 integrated in the end face 13, at least one image B or precisely one image B with a view of the end face 13a is captured (FIG. 1). The tool coordinate system W belonging to the rotary tool 13 has a predefined orientation relative to the reference coordinate system K defined by the camera 27. The rotary tool 13 can then be inserted into the clamping device 14. In so doing, a predefined relative orientation between the tool coordinate system W and the reference coordinate system K is maintained. In the exemplary embodiment shown schematically in FIG. 1, the rotary tool 13 is tilted through 90° once an image B has been captured, such that the tool longitudinal axis L is then arranged along the axis of rotation D of the clamping device 14. Once the image B has been captured, until the rotary tool 13 has been clamped, the rotary tool 13 is in no case rotated about its tool longitudinal axis L or rotated by a predefined, known angle of rotation about its tool longitudinal axis L. A correlation between the reference coordinate system K and the tool coordinate system W is therefore known to the control device 25. According to example the camera 27a is arranged in a stationary manner relative to the machine coordinate system M, such that the association of the reference coordinate system K and the machine coordinate system M is known. The machine coordinate system M in one exemplary embodiment can also be identical to the reference coordinate system K.

In a modified embodiment the camera 27a can be moved by the gripping device 36. It is then possible for example to firstly clamp the rotary tool 13 and the clamping device 14 and to capture an image B in the clamped position by means of the camera 27. To this end, the camera 27a is positioned in a predefined relative orientation in relation to the machine coordinate system M, such that the position of the at least one cutting body 35 can then be determined on the basis of the image evaluation.

On the basis of the at least one image B, the position of the at least one cutting body 35 can be determined by an image processing method. During the subsequent machining or finishing of the rotary tool 13 of the first tool type 13a the position and orientation of the at least one cutting body 35 can be taken into consideration.

If, alternatively to the camera 27a, another detection device 27 is used, the captured detection data must enable identification or determination of one or more transition points between the at least one cutting body 35 and the tool body 36. If, for example, a light or other wave-emitting detection device 27 is used, the different reflection or absorption properties of the at least one cutting body 35 and the tool body 36 can be used to determine the transition points.

If construction data of the rotary tool 13 is provided in the control device 25, for example because the rotary tool 13 is to be machined by means of the machine tool 10 within the scope of production thereof, it is sufficient to determine the position of an edge and/or surface and/or corner of a cutting body 35. At the least, not all cutting body positions have to be determined. The construction data can be used as a priori knowledge in order to calculate, on the basis of the known position of one or more of the cutting bodies 35, the positions of the other cutting bodies 35.

In the case of the second tool type 13b shown in FIGS. 1a and 3, the cutting bodies 35 are formed by cutting plates which are arranged on the tool body 34 in an accessible manner and such that they can be probed in a contact-based manner. For example, the tool body 34 can have carrier surfaces in its circumferential region, with the cutting bodies 35 embodied as cutting plates fastened on said surfaces.

The at least one image B is captured when the rotary tool 13 of the second tool type 13b is at a right angle to the tool longitudinal axis L. Ideally, the tool longitudinal axis L and the optical axis H of the camera 27a intersect one another at right angles when the at least one image B is captured. It is possible to capture a series of images B and in so doing to move the rotary tool 13 in the plane at right angles to the optical axis of the camera 27a and/or to tilt the tool longitudinal axis L relative to the optical axis H of the camera 27a. From an image sequence of this kind the image B in which the offset between the tool longitudinal axis L and the optical axis H is the smallest and the angle between the longitudinal axis L and the optical axis H (projected into a common plane) which has the smallest deviation from a right angle can be selected by image recognition methods. At least one image or a sequence of images can be captured in different rotary positions of the rotary tool 13 about the tool longitudinal axis L. At least enough images B are preferably captured that each cutting body 35 of the rotary tool 13 is captured in at least one image B.

Parallel to the tool longitudinal axis L (here: z-direction), each cutting body 35 in the case of the second tool type 13b has two edges arranged at a distance from one another, specifically a first edge 45 and on the opposite side a second edge 46. A surface 47 of the cutting body 35, which preferably constitutes a flat surface, extends between the first edge 45 and the second edge 46. The first edge 45 and the second edge 46 are connected to one another in each case via an outer edge 48 and an inner edge 49. The surface 47 is delimited by the first edge 45, the second edge 46, the outer edge 48 and the inner edge 49. The surface 47 points away from a carrier surface of the tool body 34, on which the cutting body 35 is fastened by soldering or another integrally bonded connection. In the case of the exemplary embodiment of the rotary tool 13 shown in FIG. 3, a first coordinate value z1 and a second coordinate value z2 can be determined for each cutting body 35. The first coordinate value z1 describes the position of the first edge 45 in a z-direction parallel to the tool longitudinal axis L and the second coordinate value z2 describes the position of the second edge 46 in the z-direction parallel to the tool longitudinal axis L in relation to the reference coordinate system K. The approximate position of the first edge 45 and the second edge 46 is thus known by the detection of the at least one image B.

The rotary tool 13 is inserted into the clamping device 14 once the at least one image B has been captured. The cutting bodies 35 can then be formed.

With use of the first coordinate value z1 and the second coordinate value z2, which were determined by the image evaluation, the control device 25 can determine a plurality of probe points A1 to A3 within the surface 47. According to the example three probe points A1, A2, A3 can be provided in the surface 47 in order to be able to determine the orientation of the surface 47 relative to the machine coordinate system M (FIG. 2). In addition, it is also possible to probe a fourth probe point A4 at the first edge 45 and/or a fifth probe point A5 at the second edge 46 and/or a sixth probe point A6 on the outer edge 48 in order to determine the positions of the relevant edges 45 or 46 or 48 with a higher level of accuracy. A more precise first coordinate value z1*can be determined on the basis of the probing at the fourth probe point A4, and a more precise second coordinate value z2*can be determined by the probing at the fifth probe point A5.

In addition, a first angle value α1 and optionally a second angle coordinate value α2 can be determined on the basis of one or more probe points A1-A5 and specify the rotary angle of the surface 47 or the first edge 45 or the second edge 46 about a reference plane extending along the tool longitudinal axis L and spanned for example by the x-axis and the z-axis of the reference coordinate system K. If the surface 47 is oriented parallel to this reference plane, the determination of one angle coordinate value is sufficient. The surface 47 can also be inclined relative to this reference plane, such that two angle coordinate values α1, α2 can be determined in order to describe the position of the surface 47.

In addition, at least one radial coordinate value r, which describes the distance of at least one point on the outer axis 48 from the tool longitudinal axis L is determined. This for example can be the point at which the outer edge 48 and the first edge 45 form a corner point.

The exemplary embodiment of the first tool type 13a of the rotary tool 13 shown schematically in FIGS. 4 and 5 has two cutting bodies at the end face 13s of the rotary tool 13, which cutting bodies are arranged in corresponding recesses of the tool body 34 and can be referred to as end-face cutting bodies 35s. In addition, the rotary tool 13 has inserts 50, which are formed by cutting bodies 35 integrated into the tool body 34 in a manner running in a spiral and are referred to as veins. In the blank of the rotary tool 13 shown in FIGS. 4 and 5, the inserts 50 terminate with the lateral surface of the tool body 34, such that they cannot be detected by probing. Equally, the end-face cutting bodies 35s terminate with the end face and/or the lateral surface of the tool body 34, such that probing in a contact-based manner is not possible.

The rotary tool 13 shown in FIGS. 4 and 5 shall be provided with chip flutes, clearances, cutting edges, etc. by grinding and/or erosion, for example so as to produce a spiral drill with end-face cutting bodies 35s and circumferential-side cutting bodies. Here, the tool body 34 is preferably firstly machined by grinding, and the target geometry is then machined to a finish in the same clamped position by erosion. This has the advantage that very efficient production is achieved. Compared to erosion, a greater volume of material can be removed within the same period of time in the case of grinding. However, it must be ensured that the grinding tool 16 does not come into contact with the cutting bodies 35, since otherwise the grinding tool 16 would be damaged. It is therefore important to know the position of the cutting bodies 35.

The spiral angle, the cutting body 35 forming the inserts 50, and the position thereof relative to the end-face cutting bodies 35s is known in the control device 25, since this data is necessary for the machining of the rotary tool 13 during production thereof. The end-face cutting bodies 35s each have a first edge 45 and, in the circumferential direction about the tool longitudinal axis L and at a distance therefrom, a second edge 46. On the basis of the at least one image B a first angle coordinate value α1, which specifies the angular position of the first edge 45 relative to the reference plane (FIG. 5), can be determined in relation to a reference plane extending along the tool longitudinal axis L and according to the example spanned by the z-axis and the y-axis of the tool coordinate system W. Additionally or alternatively, a second angle coordinate value α2 can be determined, which specifies the angular position of the second edge 46 of the same end-face cutting body 35s relative to the reference plane. The first and/or the second angle coordinate value α1, α2 can be determined for one or more or all end-face cutting bodies 35s.

In order to determine the angle coordinate values α1, α2 of the end-face cutting bodies 35s, it is preferably sufficient to capture a single image B at the end face 13s of the rotary tool 13.

The rotary tool 13 is positioned preferably by means of the gripping device 36 in the detection region 28 of the camera 27a and at least one image or precisely one image is captured (FIG. 1). The position of the at least one cutting body relative to the reference coordinate system K defined by the camera 27a is thus firstly given. The rotary tool 13 of the first tool type 13a is then inserted into the clamping device 14 whilst maintaining a predefined relative orientation between the reference coordinate system K, the tool coordinate system W and the machine coordinate system M. The control device therefore knows the current rotary position of at least one of the edges 45, 46 of at least one of the end-face cutting bodies 35s in relation to the machine coordinate system M. The position of the veins or inserts 50 and/or other cutting bodies 35 provided according to the example is also given on this basis, for example from construction data, present in the control device, for producing the rotary tool 13. The control device 25 can control the clamping device 14 in order to bring the clamped rotary tool 13 into a starting rotary position for machining by means of the grinding tool 16. The clamping device 14 May preferably be driven in rotation via a rotary axis rz of the axis arrangement 11, wherein the tool longitudinal axis L of the clamped rotary tool 13 coincides with an axis of rotation D of the clamping device 14 (FIG. 1).

By controlling the rotary position of the clamping device 14 about the axis of rotation D before and/or during the machining of the rotary tool 13, it can be ensured that the grinding tool 16 does not come into contact with hard end-face cutting bodies 35s or circumferential-side cutting bodies (inserts 50). The material of the tool body 34 for forming chip flutes is preferably firstly removed as far as possible by the grinding tool 16. In the same clamped position, the rotary tool 13 is then further machined by means of the eroding tool 17 in order to achieve the desired target geometry. The cutting bodies 35 forming the inserts 50 are exposed and/or machined in the circumferential region by the eroding tool 17. The end-phase cutting bodies 35s can also be machined by means of the eroding tool 17 in order to produce the target geometry.

Different tool types 13a, 13b of rotary tools 13 can be produced or reworked with the aid of the invention. The cutting bodies 35, 35s can be arranged on carrier surfaces of the tool body 34 or can be integrated in the tool body 34 by sintering or another suitable method.

At least one coordinate value z1, z2, α1, α2 of a cutting body 35, 35s can be detected by means of the camera 27a and transmitted to the control device 25. This at least one coordinate value z1, z2, α1, α2 can be used in the control device 25 for the rest of the process. This coordinate value determined on the basis of the at least one image B either can be taken into consideration directly during the machining of the rotary tool 13, or, alternatively or additionally, this at least one coordinate value z1, z2, α1, α2 determined on the basis of the at least one image B can be used in order to determine at least one further coordinate value, in particular with use of a probe device 29. Cutting bodies 35 can be sampled merely in the case of rotary tools 13 in which the cutting bodies 35 have edges that can be probed sufficiently precisely by means of the probe device 29.

### LIST OF REFERENCE SIGNS

10 machine tool
11 axis arrangement
12 tool
13 rotary tool
13a first tool type
13b second tool type
13s end face of the rotary tool
14 clamping device
16 grinding device
17 eroding tool
18 machine spindle
25 control device
26 control interface
27 detection device
27a camera
28 detection region
29 keypad device
30 probe element
31 probe body
34 tool body
35 cutting body
35s end-face cutting body
36 gripping device
37 gripping arm
38 gripper
45 first edge
46 second edge
47 surface
48 outer edge
49 inner edge
50 insert
α1 first angle value
α2 second angle value
A1 first probe point
A2 second probe point
A3 third probe point
A4 fourth probe point
A5 fifth probe point
H optical axis
K reference coordinate system
L tool longitudinal axis
M machine coordinate system
r radial coordinate value
S spindle axis
T probe signal
W tool coordinate system
z1 first coordinate value
z1* more precise first coordinate value
z2 second coordinate value
z2* more precise second coordinate value

1. A machine tool (10) which is configured to machine a material-removing rotary tool (13) with use of at least one tool (12), which rotary tool comprises a tool body (34) extending along a tool longitudinal axis (L) and at least one cutting body (35) which is fastened to the tool body (34), said machine tool comprising:
a detector (27) connected to a controller (25) for capturing detection data of the rotary tool (13) to identify a transition point between the tool body (34) and the at least one cutting body (35), and
a clamping device (14) which is configured to clamp the rotary tool (13) for machining with the at least one tool (12),
wherein the controller (25) is configured to control an axis arrangement (11) of the machine tool (10) so as to move the at least one tool (12) of the machine tool (10) and the clamping device (14) for the rotary tool (13) to be machined relative to one another and so as to position the at least one tool (12) of the machine tool (10) and the clamping device (14) for the rotary tool (13) to be machined relative to a machine coordinate system (M) of the machine tool (10),
and wherein the controller (25) is configured to determine at least one coordinate value (z1, z2, α1, α2) for each of the at least one cutting body (35) arranged on the tool body (34) on the basis of the detection data, wherein the at least one coordinate value (z1, z2, α1, α2) describes an edge position of an edge (45, 46) of a cutting body (35) in relation to a reference coordinate system (K) of the rotary tool (13),
wherein the controller (25) is configured to carry out machining of the at least one cutting body (35) by the at least one tool (12) under consideration of the at least one coordinate value (α1, α2) and/or to determine at least one further or more precise coordinate value (r, α1, α2, z1*, z2*) of the at least one cutting body (35) under consideration of the at least one coordinate value (z1, z2) obtained by the evaluation of the detection data.

2. The machine tool according to claim 1, wherein a main axis of the detector (27) is aligned with an end face of the rotary tool (13) during the capturing of the detection data.

3. The machine tool according to claim 1, further comprising a gripping device (36) configured to grip and position the rotary tool (13).

4. The machine tool according to claim 3, wherein the gripping device (36) is configured to position the rotary tool (13) in one or more orientations in a detection region (28) of the (27).

5. The machine tool according to claim 4, wherein the gripping device (36) is configured to arrange the rotary tool (13) in the clamping device (14) once the detection data has been captured, in such a way that a predefined correlation between the reference coordinate system (K) and the machine coordinate system (M) is maintained.

6. The machine tool according to claim 5, wherein the controller (25) is configured to bring the clamping device (14) with the clamped rotary tool (13) into a predefined rotary starting position about the tool longitudinal axis (L) at the start of machining by the tool (12).

7. The machine tool according to claim 1, further comprising a probe (29) that is movable relative to the rotary tool (13) by means of the axis arrangement (11).

8. The machine tool according to claim 7, wherein the probe (29) is configured to probe an edge (45, 46, 48, 49) and/or a surface (47) of the at least one cutting body (35) at least at one probe point (A1, A2, A3, A4, A5) contactlessly or in a contact-based manner.

9. The machine tool according to claim 8, wherein the controller (25) is configured to determine a plurality of probe points (A1, A2, A3, A4, A5) on the at least one cutting body (35) on the basis of the at least one coordinate value (z1, z2) determined based on the detection data.

10. The machine tool according to claim 9, wherein the controller (25) is configured to control the axis arrangement (11) such that the probe (29) probes the at least one cutting body (35) in succession at the plurality of probe points (A1, A2, A3, A4, A5), wherein the controller (25) is configured to determine one or more probe measurement values for each of the plurality of probe points (A1, A2, A3, A4, A5), the one or more probe measurement values describing a current position of the cutting body (25) at the plurality of probe points (A1, A2, A3, A4, A5) in a reference coordinate system (K).

11. The machine tool according to claim 8, wherein the controller (25) is configured to determine a more precise coordinate value (z1*, z2*) on the basis of the at least one coordinate value (z1, z2) which was determined on the basis of the detection data.

12. The machine tool according to claim 1, wherein the detector (27) comprises a camera (27a).

13. A method for preparing a machining of a material-removing rotary tool (13) which comprises a tool body (34) extending along a tool longitudinal axis (L) and has at least one cutting body (35) arranged on the tool body (34), said method comprising the following steps:
positioning the rotary tool (13) in a detection area (28) of a detector (27),
capturing detection data of the rotary tool (13) to identify a transition point between the tool body (34) and the at least one cutting body (35),
determining at least one coordinate value (z1, z2, α1, α2) of each of the at least one cutting body (35) arranged on the tool body (34) on the basis of the detection data, wherein the at least one coordinate value (z1, z2) describes an edge position of an edge (45, 46) of the at least one cutting body (35) in relation to a machine coordinate system (M) of a machine tool (10),
machining the at least one cutting body (35) by a tool (12) and/or determining at least one further coordinate value (r, α1, α2, z1*, z2*) of the at least one cutting body (25) with use of the at least one coordinate value (z1, z2, α1, α2) determined with reference to the detection data.
